(19) United States
(12) Patent Application Publication
(10) Pub. No.: US 2013/0163184 A1
(43) Pub. Date: Jun. 27, 2013

(54) ELECTRONIC APPARATUS

(71) Applicant: SONY CORPORATION, TOKYO (JP)

(72) Inventors: JIRO FUJIWARA, TOKYO (JP); TOSHIHIRO TOKITO, KANAGAWA (JP)

(73) Assignee: SONY CORPORATION, TOKYO (JP)

(21) Appl. No.: 13/712,170

(22) Filed: Dec. 12, 2012

(30) Foreign Application Priority Data
Dec. 21, 2011 (JP) 2011-279640

(51) Int. Cl. G06F 1/16

(52) U.S. Cl. CPC G06F 1/16
USPC 361/679.38

(57) ABSTRACT

An electronic apparatus includes a casing, a terminal electrode, a lock mechanism, and a driving unit. The lock mechanism includes an arm member movable between a lock position at which the arm member is engaged to an engagement portion of a storage medium and an unlock position at which it is disengaged from the engagement portion. The biasing member biases the arm member to the lock position. The arm member interferes with the storage medium moving in a first direction to move from the lock position to the unlock position and returns to the lock position at a position at which a connection terminal of the storage medium is connected to the terminal electrode to limit movement of the storage medium in a second direction opposite to the first direction. The driving unit moves the arm member from the lock position to the unlock position according to an input operation.

### BACKGROUND

The present disclosure relates to an electronic apparatus having a structure capable of preventing a storage medium from being improperly pulled out.

In general, a storage medium drive apparatus is provided inside a slot formed in an electronic apparatus. When a storage medium is inserted into the slot, a connection terminal of the storage medium is connected to a terminal electrode of the storage medium drive apparatus, so that information signals can be exchanged between the electronic apparatus and the storage medium. Regarding such a storage medium drive apparatus, if the storage medium is pulled out of the slot during a write operation of information signals with respect to the storage medium, there is a fear that a memory area of the storage medium may be damaged and information being written may be lost or the storage medium may become unusable.

In this context, there is known one having a lock mechanism that locks a storage medium with respect to a storage medium drive apparatus in a state in which the storage medium is mounted on the storage medium drive apparatus in order to prevent the storage medium during a write operation from being pulled out of the slot. For example, Japanese Patent Application Laid-open No. 2004-334562 (hereinafter, referred to as Patent Document 1) describes an electronic apparatus having the following structure. Specifically, this structure ensures a lock state by driving an electromagnetic actuator to engage a lock member to an engagement recess portion of a storage medium in a state in which the storage medium is mounted on a storage medium drive apparatus.

### SUMMARY

However, in the electronic apparatus described in Patent Document 1, in a state before the storage medium is inserted into a slot, the lock member is retained at a lock release position by keeping energization to the electromagnetic actuator. Therefore, there is a problem that excess electric power may be consumed in a stand-by state before the storage medium is inserted into the slot.

Further, in the above-mentioned electronic apparatus, after the storage medium is inserted into the slot and then a connection state between a connection terminal of the storage medium and a terminal electrode of the electronic apparatus is detected, the lock member is moved to a lock position. Therefore, it takes a certain period of time for the storage medium to transition to the lock state after the storage medium is inserted into the slot. There is a fear that the storage medium may be pulled out during a period after the establishment of the electrical connection between the connection terminal and the terminal electrode before the transition to the lock state. In this case, a heavy load is applied to a circuit that detects the above-mentioned connection state, which may lead to deterioration of the circuit.

In view of the above-mentioned circumstances, it is desirable to provide an electronic apparatus that is capable of quickly establishing a lock state of a storage medium after insertion of the storage medium without needing excess electric power upon the insertion.

According to an embodiment of the present disclosure, there is provided an electronic apparatus including a casing, a terminal electrode, a lock mechanism, and a driving unit.

The casing includes an insertion port into which a storage medium including a connection terminal and an engagement portion in an outer peripheral surface thereof is to be inserted in a first direction, and a first button for ejecting the storage medium from the insertion port in a second direction opposite to the first direction.

The terminal electrode is provided inside the casing and configured to be connectable to the connection terminal.

The lock mechanism includes an arm member configured to be movable between a lock position at which the arm member is engaged to the engagement portion and an unlock position at which the arm member is disengaged from the engagement portion, and a biasing member configured to bias the arm member to the lock position. The arm member interferes with the storage medium moving in the first direction to move from the lock position to the unlock position, and returns to the lock position at a position at which the connection terminal is connected to the terminal electrode to limit movement of the storage medium in the second direction. The lock mechanism is provided between the insertion port and the terminal electrode.

The driving unit is configured to move the arm member from the lock position to the unlock position according to an input operation with respect to the first button.

In the electronic apparatus, the arm member is configured to stand by at the lock position using the biasing member in a stand-by state before the storage medium is inserted into the insertion port. Accordingly, according to the electronic apparatus, it is possible to quickly ensure the lock state of the storage medium after insertion of the storage medium without needing excess electric power upon the insertion.

The lock mechanism may further include a rotating shaft configured to abut against the storage medium moving in the first direction, to thereby rotate the arm member from the lock position to the unlock position.

Accordingly, it is possible to smoothly move the arm member from the lock position to the unlock position, and hence to ensure a suitable insertion operation of the storage medium.

The driving unit may include a cam configured to be engageable to the arm member, a motor configured to rotate the cam, and a control unit configured to control driving of the motor.

Accordingly, it is possible to realize simplification of a configuration of the lock mechanism. At the same time, it is possible to move the arm member between the lock position and the unlock position due to a rotation operation of the motor in one direction.

The driving unit may further include a sensor configured to detect a rotation position of the cam. In this case, the control unit is configured to control the driving of the motor based on an output from the sensor.

Accordingly, it is possible to accurately move the arm member to the lock position or the unlock position.

The electronic apparatus may further include a second button. The second button is provided to the casing to mechanically move the arm member from the lock position to the unlock position by a pressing operation.

Accordingly, it is possible to easily eject the storage medium from the insertion port also during power-off, for example.

The driving unit may be configured to return the arm member to the lock position after the driving unit moves the arm member from the lock position to the unlock position and a predetermined period of time elapses.

Accordingly, it is possible to return the arm member to the lock position after ejection of the storage medium.

The driving unit may be configured to move the arm member from the lock position to the unlock position again when the driving unit detects a power-off operation after the driving unit returns the arm member to the lock position.

Accordingly, it is possible to freely perform insertion and ejection of the storage medium into/from the insertion port.

As described above, according to the embodiments of the present disclosure, it is possible to quickly ensure a lock state of a storage medium after insertion of the storage medium without needing excess electric power upon the insertion.

These and other objects, features and advantages of the present disclosure will become more apparent in light of the following detailed description of best mode embodiments thereof, as illustrated in the accompanying drawings.

### BRIEF DESCRIPTION OF DRAWINGS

FIG. 1 is a perspective view showing an entire configuration of an electronic apparatus according to an embodiment of the present disclosure;

FIG. 2 is a front view of main parts of the electronic apparatus;

FIG. 3 is an entire perspective view of a storage medium to be used in the electronic apparatus;

FIG. 4 is a schematic configuration view of a drive apparatus incorporated in the electronic apparatus;

FIG. 5 is an entire view showing an example of a configuration of the drive apparatus;

FIG. 6 is an enlarged view showing a lock mechanism of the drive apparatus and a peripheral structure thereof;

FIG. 7 is a side view of the drive apparatus shown in FIG. 6;

FIG. 8 is a flowchart explaining an operation example and a control example of the electronic apparatus;

FIG. 9 is a main part enlarged view of the drive apparatus, which explains an action of a lock mechanism when the storage medium is inserted into the drive apparatus;

FIG. 10 is a main part enlarged view of the drive apparatus, which explains a lock state of the storage medium;

FIG. 11 is a main part enlarged view of the drive apparatus, which explains an unlock operation with respect to the storage medium;

FIG. 12 is a main part enlarged view of the drive apparatus, which explains another unlock operation with respect to the storage medium; and

FIG. 13 is a circuit diagram explaining a modified example of a configuration of the electronic apparatus.

### DETAILED DESCRIPTION OF EMBODIMENTS

Hereinafter, an embodiment of the present disclosure will be described with reference to the drawings.

### [Entire Configuration of Electronic Apparatus]

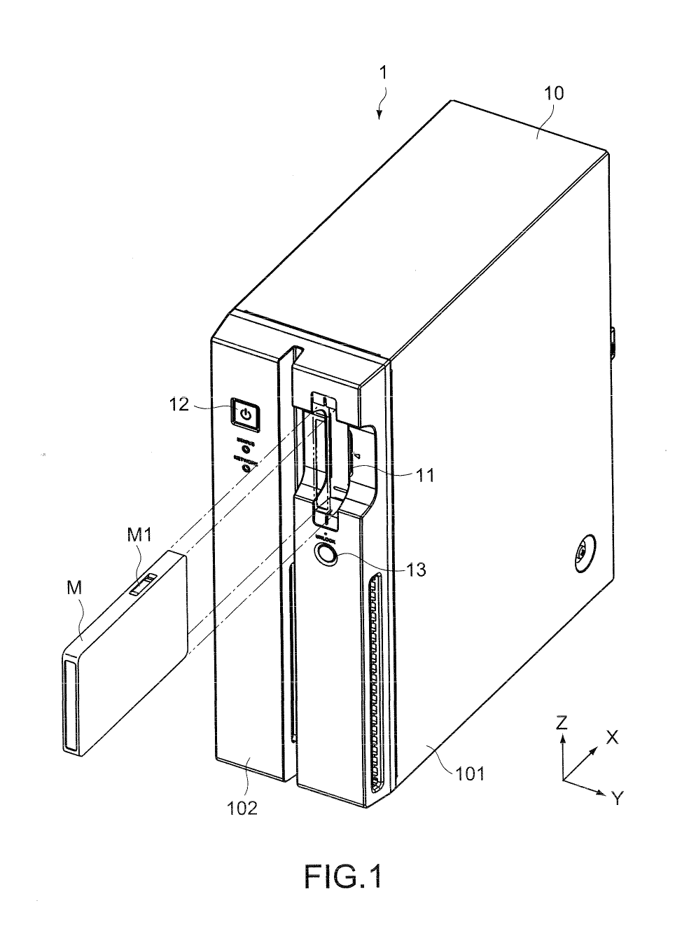

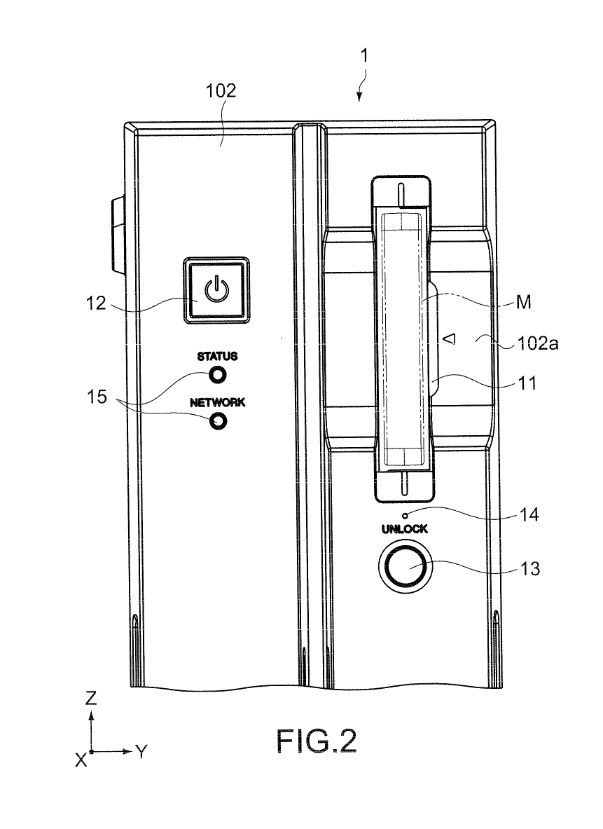

FIG. 1 is a perspective view showing an entire configuration of an electronic apparatus according to an embodiment of the present disclosure. FIG. 2 is a front view of main parts of the electronic apparatus. In the figures, an X-axis direction and a Y-axis direction indicate horizontal directions orthogonal to each other and a Z-axis direction indicates a vertical direction.

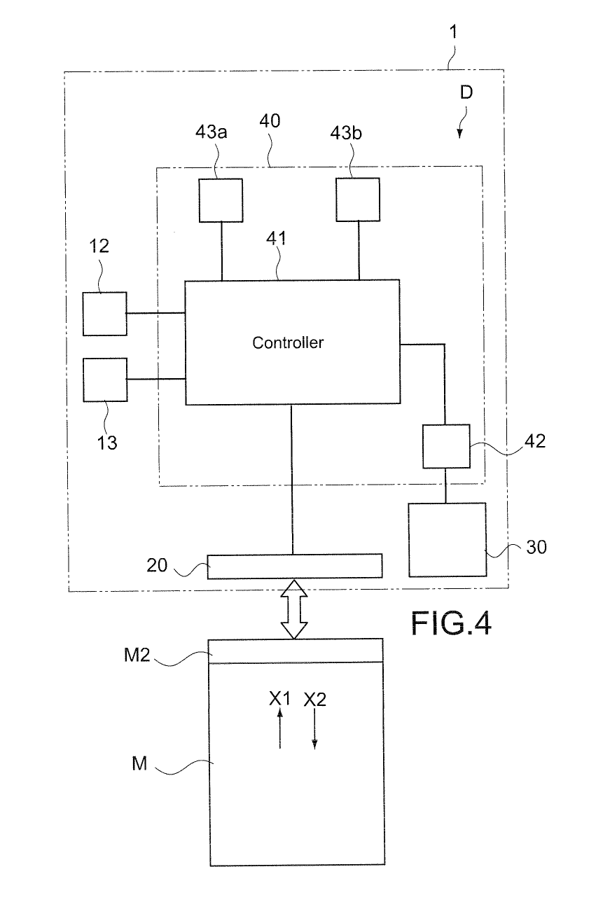

An electronic apparatus 1 according to this embodiment includes a casing 10 and a drive apparatus D (see FIG. 4). The casing 10 includes an insertion port 11 into which a storage medium M is to be inserted. The drive apparatus D is provided inside the casing 10. The electronic apparatus 1 is configured as a data processing apparatus that processes data stored in the storage medium M. For example, the electronic apparatus 1 according to this embodiment is connected to an information processing apparatus (not shown) and configured as a data transferring apparatus that transfers data read from the storage medium M to the information processing apparatus.

The casing 10 includes a casing main body 101 and a front panel 102. The casing main body 101 is opened at a front surface portion thereof and has a cuboid shape. The front panel 102 is attached to the front surface portion of the casing main body 101 and includes the insertion port 11 formed therein. The front panel 102 is, at a position near the insertion port 11, provided with an unlock button 13 (first button). The unlock button 13 is to be pressed and operated upon ejection of the storage medium M.

The insertion port 11 is formed of a slot having a longitudinal direction in the Z-axis direction. The storage medium M is inserted or ejected into/from the insertion port 11 along the X-axis direction. For an ejection operation of the storage medium M from the insertion port 11, as will be described later, the unlock button 13 is pressed and operated and then a pull-out operation by a user ejects the storage medium M from the insertion port 11. In order to easily perform the ejection operation of the storage medium M at this time, a recess portion 102a is formed in part of an area in which the insertion port 11 is formed so that part of rear end of the storage medium M inserted into the insertion port 11 partially projects from the front panel 102.

The front panel 102 further includes a power supply button 12, an emergency button 14 (second button), display portions 15 that display various operation states of the electronic apparatus 1, and the like.

The power supply button 12 is constituted of a press switch for switching between supplying and cutting off power to the electronic apparatus 1. As will be described later, the emergency button 14 is pressed and operated when the storage medium M is ejected from the insertion port 11 in a state in which power to the electronic apparatus 1 is cut off. The display portions 15 include a plurality of light emitting diodes (LEDs) as light sources. The display portions 15 are configured to blink in predetermined light-emitting patterns depending on an operation state (status, network connection status, or the like) of the electronic apparatus 1.

As shown in FIG. 1, the electronic apparatus 1 is not limited to a case where the longitudinal direction of the front panel 102 is set to be parallel to the vertical direction. The longitudinal direction may be set to be parallel to the horizontal direction (e.g., Y-axis direction).

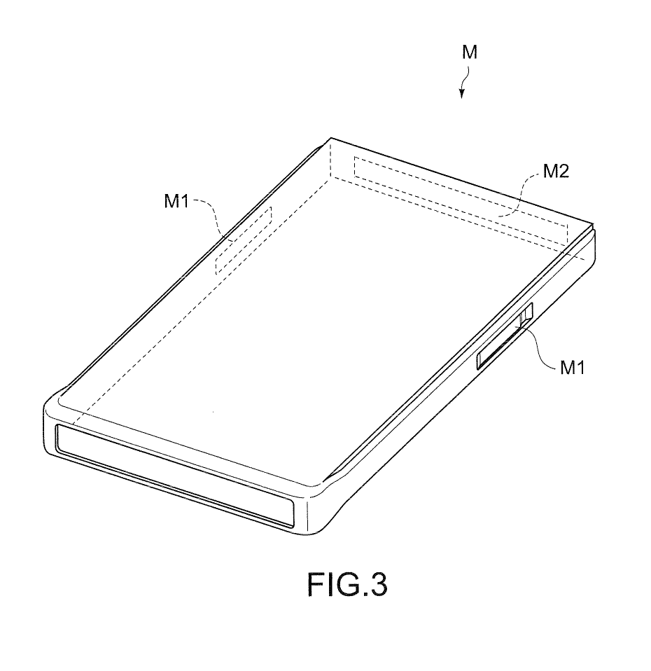

FIG. 3 is a perspective view showing an entire storage medium M.

The storage medium M is configured as a plate-like package memory that incorporates a semiconductor memory having a predetermined capacity (e.g., 256 GB) and includes engagement portions M1 and a connection terminal M2 in an outer peripheral surface thereof. The storage medium M is used as, for example, a removable storage medium for storing broadcast materials and stores image data captured by an imaging camera (not shown).

The engagement portions M1 are each constituted of a recessed portion or a groove formed at a predetermined position in each of side surfaces of the storage medium M. The engagement portions M1 are not limited to the example in which the engagement portions M1 are formed in the both side surfaces of the storage medium. The engagement portion M1 may be formed in only a side surface on one side.

The connection terminal M2 is constituted of a plurality of connection pins formed in an insertion-side end portion (leading end portion) of the storage medium M. By the storage medium M being inserted into the insertion port 11, the connection terminal M2 is electrically connected to the drive apparatus provided inside the electronic apparatus 1.

### [Drive Apparatus]

Next, the drive apparatus will be described in detail.

FIG. 4 is a schematic configuration view of the drive apparatus D according to this embodiment. The drive apparatus D includes a terminal electrode 20, a lock mechanism 30, and a driving unit 40.

The terminal electrode 20 is provided inside the casing 10 and configured to be connectable to the connection terminal M2 of the storage medium M inserted from the insertion port along an X1 direction (first direction). The terminal electrode 20 is electrically connected to a controller 41 of the driving unit 40.

The lock mechanism 30 serves to prevent the storage medium M inserted into the insertion port 11 from being improperly pulled out. That is, the lock mechanism 30 has a function of preventing a pull-out operation of the storage medium M from the insertion port 11 by the user without using a predetermined unlock operation in a state in which the connection terminal M2 of the storage medium M is connected to the terminal electrode 20.

As will be described later, the lock mechanism 30 is configured to allow movement of the storage medium M along the X1 direction and to limit movement of the storage medium M along an X2 direction opposite to the X1 direction in a state in which the connection terminal M2 is connected to the terminal electrode 20.

The driving unit 40 includes a controller 41 (control unit), a driving portion 42 that drives the lock mechanism 30, a lock-position sensor 43a, and an unlock-position sensor 43b. The controller 41 controls the driving portion 42 based on outputs from the power supply button 12, the unlock button 13, the lock-position sensor 43a, and the unlock-position sensor 43b. The controller 41 has a function of switching the lock mechanism 30 from a lock state to an unlock state, mainly based on input operations of the power supply button 12 and the unlock button 13.

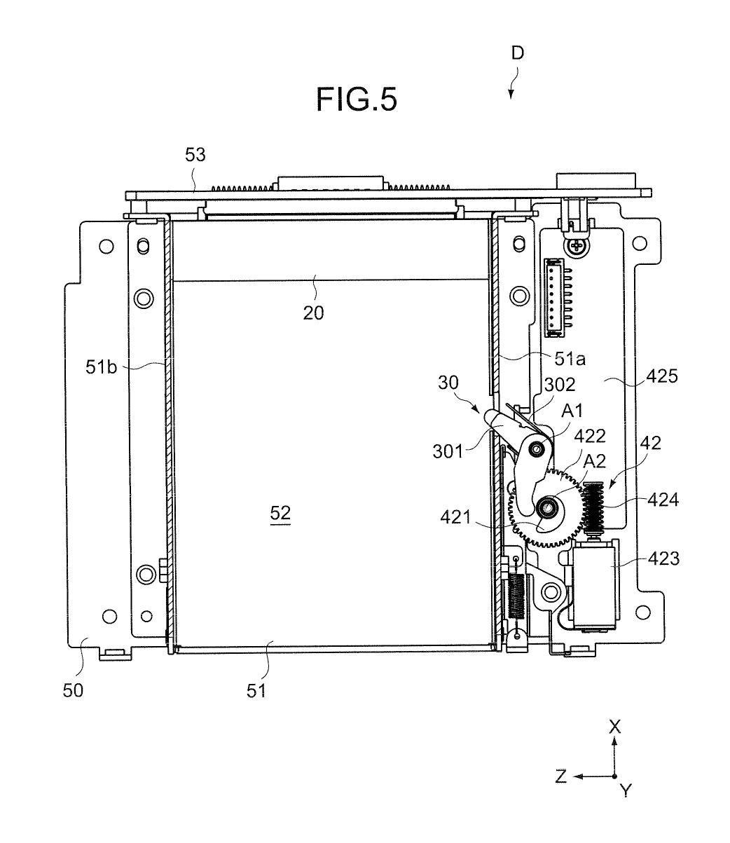

Next, referring to FIG. 5, the drive apparatus D will be described in detail. FIG. 5 is a plan view as viewed in the Y-axis direction, which shows a configuration of the drive apparatus D.

The drive apparatus D includes a metal base plate 50 to be fixed inside the casing 10, the terminal electrode 20 fixed in the base plate 50, and a metal holder 51 provided to the base plate 50. The holder 51 includes therein a passageway 52 that communicates between the insertion port 11 and the terminal electrode 20. The connection terminal M2 of the storage medium M inserted into the insertion port 11 is guided via the passageway 52 to a position of connection to the terminal electrode 20.

Inner space (passageway 52) of the holder 51 has a slightly larger dimension than a width and a thickness of the storage medium M and configured as a housing that holds a state of connection of the storage medium M to the terminal electrode 20, the storage medium M being housed in the passageway 52. The holder 51 includes a pair of side wall portions 51a and 51b that are opposed to the both side surfaces of the storage medium M and limits movement of the storage medium M in a width direction (Z-axis direction in FIG. 5) within the passageway 52. The terminal electrode 20 is placed to be opposed to the connection terminal M2 of the storage medium M on a circuit board 53 to be electrically connected to the controller 41 (FIG. 4).

The lock mechanism 30 is provided between the insertion port 11 and the terminal electrode 20. In this embodiment, the lock mechanism 30 is placed on the base plate 50 and provided outside the side wall portion 51a of the holder 51. The lock mechanism 30 includes an arm member 301 and a biasing member 302.

The arm member 301 is configured to be movable between a lock position at which the arm member 301 is engageable to one of the engagement portions M1 of the storage medium M and an unlock position at which the arm member 301 is disengaged from the engagement portion M1. In this embodiment, the arm member 301 is supported to the support shaft A1 (rotating shaft) and configured to be rotatable between the lock position and the unlock position. The biasing member 302 is constituted of an elastic member that biases the arm member 301 to the lock position. In this embodiment, a torsion spring is used as the biasing member 302.

The driving portion 42 of the driving unit 40 includes a cam 421, a motor 423, and a motor substrate 425. The cam 421 is engageable to the arm member 301. The motor 423 rotates the cam 421 in a counterclockwise direction in FIG. 5. The motor substrate 425 serves to drive the motor 423. The cam 421 is formed in one surface of a gear 422 supported by a support shaft A2 and configured to be engageable to the arm member 301 depending on a rotation position of the gear 422. The motor 423 includes a rotating shaft to which a worm gear 424 that meshes with the gear 422 is provided. The motor substrate 425 is electrically connected to the motor 423 and the controller 41 (FIG. 4). The motor substrate 425 installs various circuit components for generating a driving signal to be outputted to the motor 423 according to a control signal from the controller 41.

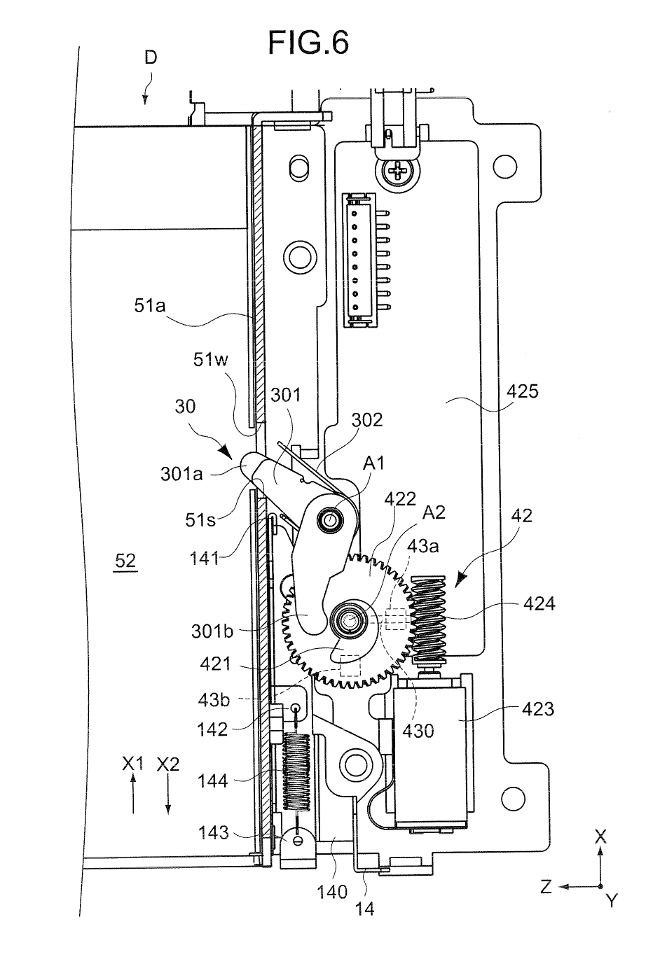

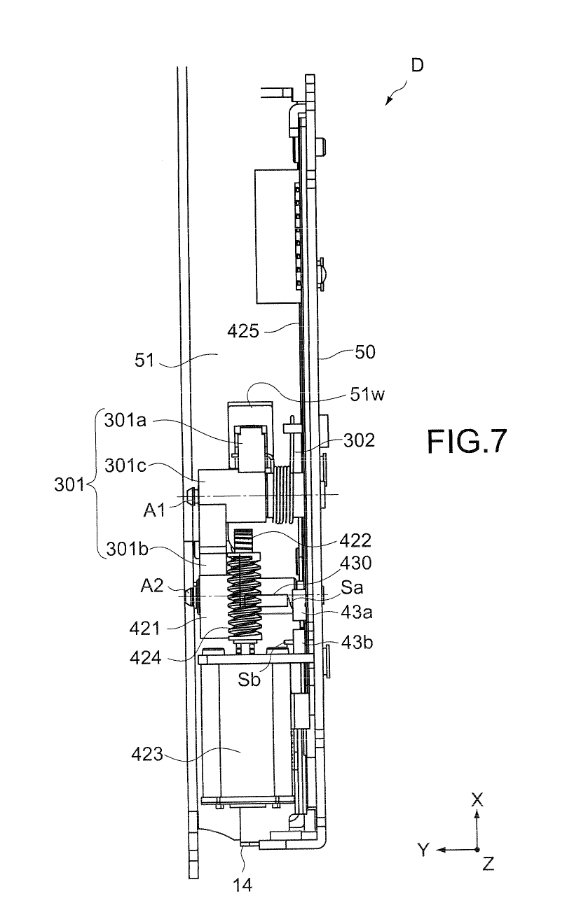

FIG. 6 is an enlarged view showing the details of the lock mechanism 30 and the driving portion 42. FIG. 7 is a side view of the drive apparatus D in FIG. 6 as viewed in the Z-axis direction.

The arm member 301 includes a first arm portion 301a, a second arm portion 301b, and a coupling portion 301c. The coupling portion 301c couples the first arm portion 301a and the second arm portion 301b to each other and is provided to the support shaft A1 to be rotatable. The first arm portion 301a rotates about the support shaft A1 to take either one of a lock position and an unlock position. Specifically, at the lock position, the first arm portion 301a projects to the inside of the passageway 52 through an opening 51w formed in the side wall portion 51a of the holder 51. At the unlock position, the first arm portion 301a retracts to the outside of the passageway 52. The second arm portion 301b extends to a position at which the second arm portion 301b is engageable to the cam 421. The second arm portion 301b rotates the first arm portion 301a via the coupling portion 301c due to engagement to the cam 421 that rotates in the counterclockwise direction in FIG. 6.

The biasing member 302 includes one end that is retained at a suitable position on the base plate 50 and the other end that is retained by the first arm portion 301a so as to constantly bias the arm member 301 to the lock position. The first arm portion 301a abuts against an end portion 51s of the opening 51w formed in the side wall portion 51a of the holder 51, so that the amount of projection to the passageway 52 side is limited.

The gear 422 is provided between the second arm portion 301b of the arm member 301 and the base plate 50 and fixed to the support shaft A2 to be rotatable. In one surface of the gear 422, the cam 421 is integrally formed. In the other surface of the gear 422, an actuating plate 430 capable of actuating the lock-position sensor 43a and the unlock-position sensor 43b installed on the motor substrate 425 is formed to project toward the base plate 50. The actuating plate 430 has a length corresponding to a radius of the gear 422 and rotates about the support shaft A2 together with the gear 422.

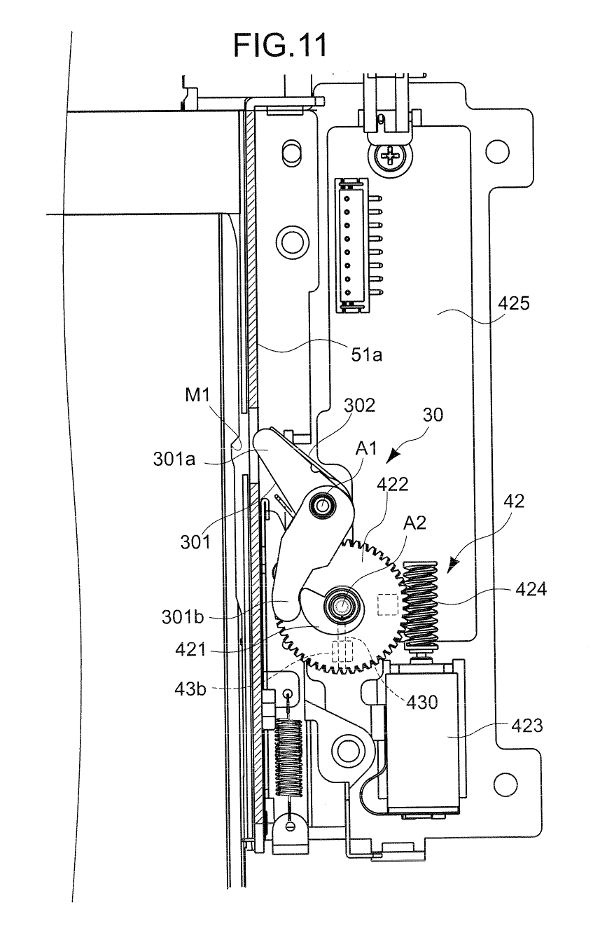

The lock-position sensor 43a and the unlock-position sensor 43b are provided between the gear 422 and the base plate 50. As shown in FIG. 7, the lock-position sensor 43a and the unlock-position sensor 43b include actuators Sa and Sb at positions at which the actuators Sa and Sb are engaged to the actuating plate 430 of the gear 422, respectively. The lock-position sensor 43a and the unlock-position sensor 43b are configured to generate predetermined outputs by being mechanically pressed due to engagement to the actuating plate 430. The lock-position sensor 43a and the unlock-position sensor 43b serve to detect a rotation position of the cam 421. The lock-position sensor 43a is provided to be opposed to the actuating plate 430 at a rotation position (FIG. 6) of the gear 422 that rotates the arm member 301 to the lock position. At the rotation position of the cam 421, a gap having a predetermined size or more is formed between the second arm portion 301b and the cam 421. Within this gap, a rotating operation of the arm member 301 is allowed. Meanwhile, the unlock-position sensor 43b is provided to be opposed to the actuating plate 430 at the rotation position (FIG. 11) of the gear 422 that rotates the arm member 301 to the unlock position.

The drive apparatus D further includes a push plate 140. The push plate 140 is provided between the gear 422 and the base plate 50 in the outside of the side wall portion 51a of the holder 51 and configured to be movable in the X-axis direction along an outer surface of the side wall portion 51a. A front end portion 141 of the push plate 140 is opposed to the first arm portion 301a of the arm member 301. A rear end portion of the push plate 140 forms the emergency button 14 facing the front panel 102.

In the push plate 140, a first retaining piece 142 configured to retain one end of a coil spring 144 is formed. In the base plate 50, a second retaining piece configured to retain the other end of the coil spring 144 is formed. The push plate 140 is biased by the coil spring 144 to a stand-by position shown in FIG. 6. Normally, the push plate 140 is retracted to such a position that the front end portion 141 of the push plate 140 and the arm member 301 are not held in contact with each other.

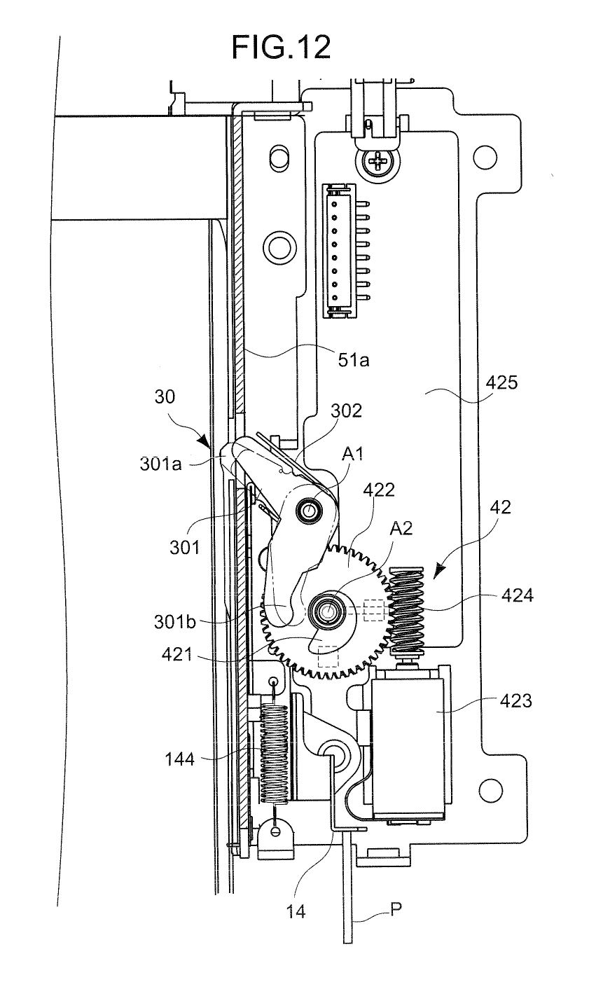

On the other hand, the push plate 140 moves along the X1 direction against a biasing force of the coil spring 144 by a pressing operation with respect to the emergency button 14 using a predetermined operating member P. FIG. 12 is an enlarged view showing the lock mechanism 30 when the emergency button 14 is pressed and operated. In this case, the front end portion 141 of the push plate 140 presses the first arm portion 301a located at the lock position in the X1 direction to mechanically move the arm member 301 from the lock position to the unlock position.

As described above, the electronic apparatus 1 according to this embodiment is configured to be capable of releasing the lock state of the storage medium M also by operating the emergency button 14. The emergency button 14 is typically provided at a position depressed from the surface of the front panel 102 to the inside of the apparatus in order to prevent the storage medium M from being improperly ejected. Further, in order to prevent an operation by a finger, the emergency button 14 is configured to be operated with a relatively thin jig such as a pin. Therefore, the emergency button 14 is not intended for normal use. The emergency button 14 is used when a normal unlock operation is not effective because the apparatus is out of control for some reasons.

### [Operation of Electronic Apparatus]

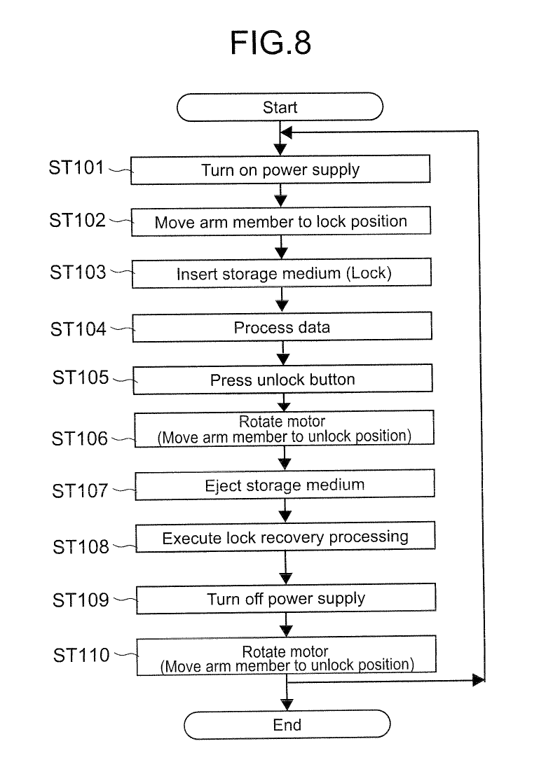

Next, a typical operation of the electronic apparatus 1 will be described. FIG. 8 is a flowchart showing an operation example with respect to the electronic apparatus 1 and an operation example of the driving unit 40.

By the power supply button 12 being pressed and operated, the controller 41 of the driving unit 40 detects a power-on operation (Step ST101). Accordingly, the controller 41 drives the motor 423 to rotate the gear 422, so that the arm member 301 is moved to the lock position shown in FIG. 6 (Step ST102).

The controller 41 detects the lock position of the arm member 301 based on an output from the lock-position sensor 43a. The lock-position sensor 43a detects pressing of the actuator Sa by the actuating plate 430 of the gear 422 and supplies an output signal of the detection to the controller 41. The controller 41 stops driving of the motor 423 based on an output from the lock-position sensor 43a. Accordingly, it is possible to accurately move the arm member 301 to the lock position.

At this time, as shown in FIG. 6, the cam 421 on the gear 422 is not engaged to the arm member 301. Therefore, the arm member 301 receives a biasing force of the biasing member 302 and is moved to the lock position at which the arm member 301 projects to the inside of the passageway 52 through the opening 51w of the side wall portion 51a. Accordingly, a state of standing by for an insertion operation of the storage medium M into the insertion port 11 (stand-by state) is set.

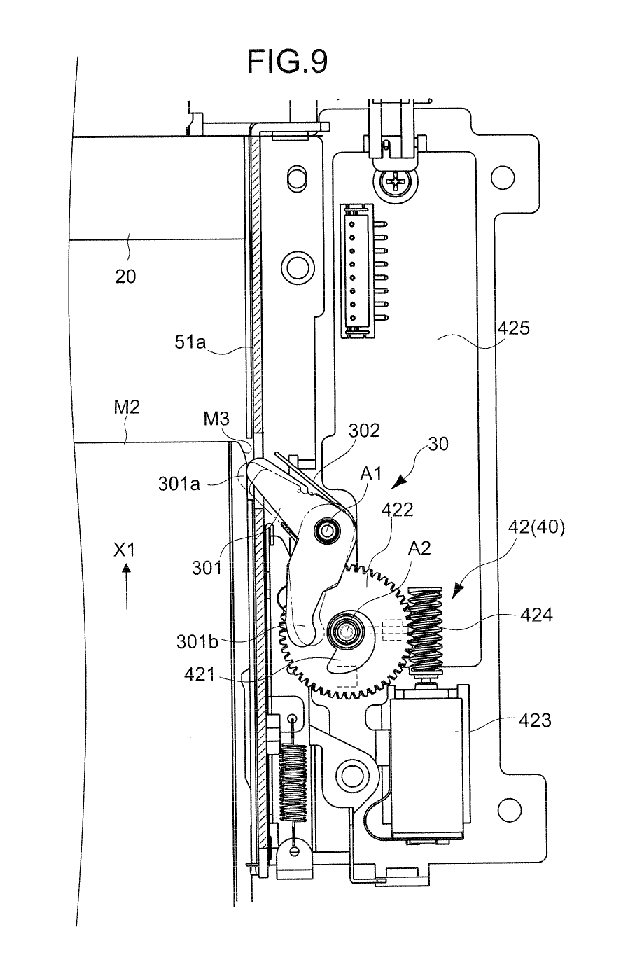

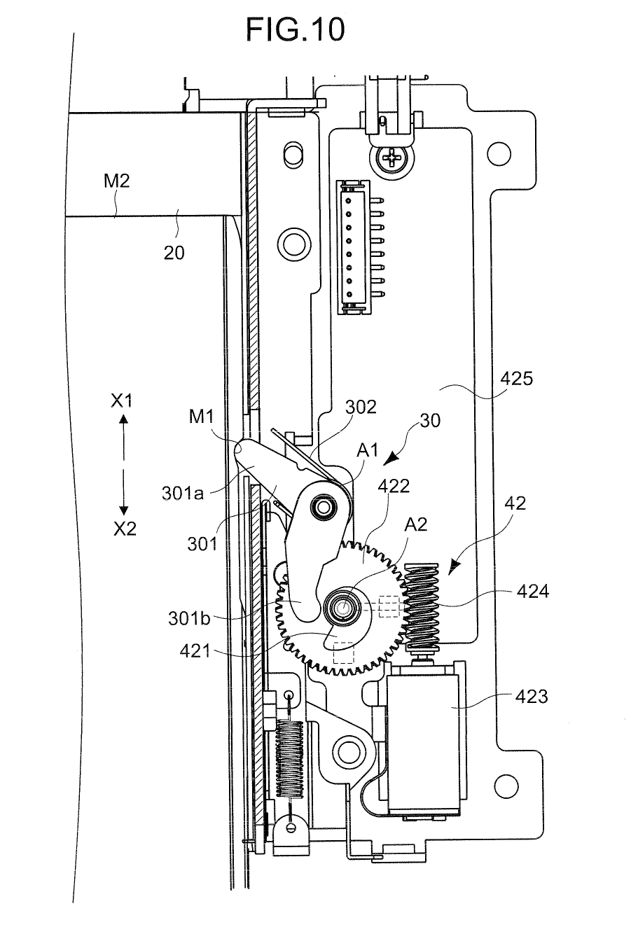

When the storage medium M is inserted into the insertion port 11 (Step ST103), the lock mechanism 30 transitions to a state in which the lock mechanism 30 automatically locks the storage medium M without being controlled by the driving unit 40 (FIGS. 9 and 10).

FIGS. 9 and 10 are enlarged views of main parts, which explain a lock operation of the storage medium M by the lock mechanism 30. The storage medium M inserted into the insertion port 11 is guided by the both side wall portions 51a and 51b of the holder 51 and moves along the X1 direction within the passageway 52. In this moving process, the first arm portion 301a of the arm member 301 interferes with (abuts against) the storage medium M, to thereby move from the lock position to the outside of the side wall portion 51a (unlock position side) as shown in FIG. 9. Accordingly, the storage medium M is allowed to enter the passageway 52 without being inhibited from moving along the X1 direction.

Here, a taper portion M3 is formed at a corner of an insertion end of the storage medium M, and hence it is possible to smoothly perform the movement of the arm member 301 from the lock position to the unlock position.

On the other hand, the arm member 301 constantly receives a biasing force of the biasing member 302, and hence abuts against a peripheral side surface of the storage medium M during the movement of the storage medium M. Then, as shown in FIG. 10, when the storage medium M arrives at such a position that the connection terminal M2 of the storage medium M is connected to the terminal electrode 20, the arm member 301 is engaged to the engagement portion M1 of the storage medium M. The engagement portion M1 is formed of the recessed portion, and hence engaged to a distal end portion of the arm member 301 (first arm portion 301a), so that movement of the storage medium M in the X2 direction (pull-out direction) is limited. Accordingly, the lock state of the storage medium M by the lock mechanism 30 is established.

According to this embodiment, the arm member 301 stands by at the lock position due to the biasing force of the biasing member 302, and hence electric power for the arm member 301 standing by at the lock position is unnecessary. Thus, it is possible to cause the lock mechanism 30 to stand by at the lock position without feeding electric power. Further, connection of the storage medium M to the terminal electrode 20 and establishment of the lock state of the storage medium M can be performed at the same time. Therefore, it is possible to quickly ensure the lock state of the storage medium after insertion.

Further, the arm member 301 is configured to be rotatable with the support shaft A1 being a supporting point. Therefore, it is possible to smoothly perform movement of the arm member 301 from the lock position to the unlock position using interference with the storage medium M and to ensure a suitable insertion operation of the storage medium M.

Subsequently, the controller 41 checks a state of electrical connection to the storage medium M based on an output from the terminal electrode 20, and then executes a processing step of data stored in the storage medium M (Step ST104). As the data processing step, in this embodiment, stored data of the storage medium M is read via the terminal electrode 20 and the read data is transferred to the information processing apparatus (not shown) or outputted to a display apparatus (not shown) to reproduce video.

After completion of the data processing, if a pressing operation of the unlock button 13 by the user is detected by the controller 41 (Step ST105), then the controller 41 drives the motor 423 so that the gear 422 rotates about the support shaft A2 in the counterclockwise direction by a predetermined angle as shown in FIG. 11. Accordingly, the arm member 301 is moved to the unlock position (Step ST106).

FIG. 11 shows a state when the arm member 301 is located at the unlock position. The controller 41 detects the unlock position of the arm member 301 based on an output from the unlock-position sensor 43b. The unlock-position sensor 43b detects pressing of an actuator Sb by the actuating plate 430 of the gear 422 and supplies an output signal of the detection to the controller 41. The controller 41 stops driving of the motor 423 based on an output from the unlock-position sensor 43b. Accordingly, it is possible to accurately move the arm member 301 to the unlock position.

At the time, as shown in FIG. 11, the cam 421 on the gear 422 is engaged to the arm member 301 (second arm portion 301b). Therefore, the arm member 301 (first arm portion 301a) receives the biasing force of the biasing member 302 and is moved to the unlock position at which the arm member 301 is retracted to the outside of the side wall portion 51a. Accordingly, the lock state of the storage medium M is released and a pull-out operation of the storage medium M along the X2 direction is allowed (Step ST107).

The controller 41 moves the arm member 301 from the lock position to the unlock position. Based on an output from the terminal electrode 20, the controller 41 determines on the ground of electrical disconnection from the storage medium M that the storage medium M is ejected. After a predetermined period of time elapses, the controller 41 executes processing of returning the arm member 301 to the lock position (Step ST108).

Accordingly, during a period after the storage medium M is ejected from the insertion port 11, for example, before another storage medium is inserted into the insertion port 11, the return of the arm member 301 to the lock position is allowed, and a suitable lock operation as described above is ensured upon insertion of that storage medium. The predetermined period of time described above is not particularly limited. For example, the predetermined period of time may be set to be several seconds to several minutes.

The controller 41 detects a power-off operation by the power supply button 12 being pressed and operated again (Step ST109). Then, the controller 41 drives the motor 423 and rotates the gear 422 to move the arm member 301 to the unlock position shown in FIG. 11 again (Step ST110). Accordingly, insertion and ejection of the storage medium into/from the insertion port 11 can be freely performed.

In particular, in this embodiment, in the stand-by state before the storage medium M is inserted, the arm member 301 of the lock mechanism 30 is mechanically biased to the lock position, and a control of the driving of the motor 423 by the controller 41 is not allowed during power-off. Therefore, in a state in which the arm member 301 remains at the lock position during power-off, the unlock operation cannot be performed unless the power supply is turned on again or the emergency button 14 is operated after the storage medium M is inserted. Such operations cause inconvenience to the user in some cases. Therefore, in this embodiment, when the power-off operation is performed, the lock mechanism 30 is held in the unlock state and power-OFF processing is executed.

As described above, according to this embodiment, it is possible to quickly ensure the lock state of the storage medium after insertion of the storage medium M without needing excess electric power upon the insertion. Accordingly, it is possible to achieve power saving of the electronic apparatus 1 and to prevent an improper ejection operation of the storage medium, so that protection of data stored in the storage medium can be achieved.

Further, after the storage medium M is connected to the terminal electrode 20, the storage medium is prevented from being pulled out while a connection state between the storage medium M and the terminal electrode 20 is electrically detected by the controller 41. Therefore, it is possible to effectively avoid deterioration of the detection circuit due to a heavy load on the detection circuit.

In addition, according to this embodiment, only rotational driving of the motor 423 in one direction can move the arm member 301 between the lock position and the unlock position. Therefore, simplification of the configuration and control can be achieved.

Although the embodiment of the present disclosure has been described above, the present disclosure is not limited only to the above-mentioned embodiment, and it is needless to say that various modifications can be made without departing from the gist of the present disclosure.

For example, in the above-mentioned embodiment, the cam is used for moving the arm member from the lock position to the unlock position. However, how to move the arm member is not limited thereto. For example, a plunger, a ball screw unit, or the like linearly moved by driving of a solenoid may be used for directly pressing the arm member to move the arm member from the lock position to the unlock position.

Further, although the lock mechanism 30 is provided in the side wall portion 51a on the one side of the holder 51, the lock mechanism 30 is not limited thereto. The lock mechanism 30 may be provided on the side wall portion 51b on the other side. Alternatively, the lock mechanism 30 may be provided in each of the side wall portions 51a and 51b.

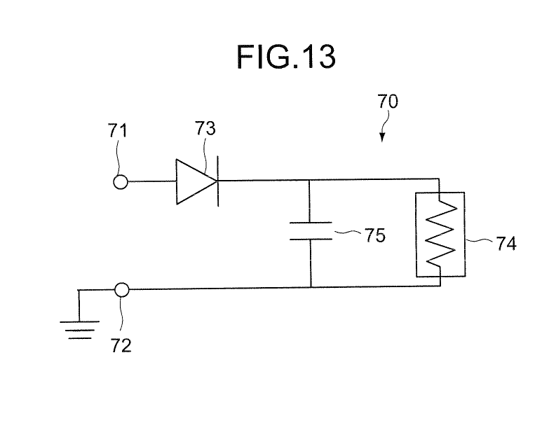

In addition, for example, a spare circuit 70 shown in FIG. 13 may be incorporated in the electronic apparatus. This circuit 70 includes a power-supply terminal 71 to be connected to a commercial power supply, an earth terminal 72, a rectifying device 73 and a load 74 that are provided between the power-supply terminal 71 and the earth terminal 72, and a capacitor 75 provided in parallel with respect to the rectifying device 73 between the power-supply terminal 71 and the earth terminal 72. In the above-mentioned embodiment, the load 74 corresponds to a driving circuit of the motor 423 that moves the arm member 301. Even if power is cut off without operating a power-supply button while the arm member is located at the lock position, this spare circuit 70 can move the arm member to the unlock position using an electrical charge accumulated in the capacitor 75. The capacitance of the capacitor 75 is appropriately set depending on a resistance of the load 74, a driving time, a driving current, and the like. For example, the capacitance of the capacitor 75 is set to be several hundreds to several thousands of MF.

It should be noted that the present disclosure may also take the following configurations.

(1) An electronic apparatus, including:

a casing including
an insertion port into which a storage medium including a connection terminal and an engagement portion in an outer peripheral surface thereof is to be inserted in a first direction, and
a first button for ejecting the storage medium from the insertion port in a second direction opposite to the first direction;

a terminal electrode that is provided inside the casing and configured to be connectable to the connection terminal;

a lock mechanism including
an arm member configured to be movable between a lock position at which the arm member is engaged to the engagement portion and an unlock position at which the arm member is disengaged from the engagement portion, and
a biasing member configured to bias the arm member to the lock position, the arm member interfering with the storage medium moving in the first direction to move from the lock position to the unlock position and returning to the lock position at a position at which the connection terminal is connected to the terminal electrode to limit movement of the storage medium in the second direction, the lock mechanism being provided between the insertion port and the terminal electrode; and

a driving unit configured to move the arm member from the lock position to the unlock position according to an input operation with respect to the first button. (2) The electronic apparatus according to (1), in which

the lock mechanism further includes a rotating shaft configured to abut against the storage medium moving in the first direction, to thereby rotate the arm member from the lock position to the unlock position.

(3) The electronic apparatus according to (1) or (2), in which

the driving unit includes
a cam configured to be engageable to the arm member,
a motor configured to rotate the cam, and
a control unit configured to control driving of the motor.
   (4) The electronic apparatus according to (3), in which

the driving unit further includes a sensor configured to detect a rotation position of the cam, and

the control unit is configured to control the driving of the motor based on an output from the sensor.

(5) The electronic apparatus according to any one of (1) to (4), further including

a second button that is provided to the casing to mechanically move the arm member from the lock position to the unlock position by a pressing operation.

(6) The electronic apparatus according to any one of (1) to (5), in which

the driving unit is configured to return the arm member to the lock position after the driving unit moves the arm member from the lock position to the unlock position and a predetermined period of time elapses.

(7) The electronic apparatus according to (6), in which

the driving unit is configured to more the arm member from the lock position to the unlock position again when the driving unit detects a power-off operation after the driving unit returns the arm member to the lock position.

The present disclosure contains subject matter related to that disclosed in Japanese Priority Patent Application JP 2011-279640 filed in the Japan Patent Office on Dec. 21, 2011, the entire content of which is hereby incorporated by reference.

What is claimed is:

1. An electronic apparatus, comprising:
a casing including
an insertion port into which a storage medium including a connection terminal and an engagement portion in an outer peripheral surface thereof is to be inserted in a first direction, and
a first button for ejecting the storage medium from the insertion port in a second direction opposite to the first direction;
a terminal electrode that is provided inside the casing and configured to be connectable to the connection terminal;
a lock mechanism including
an arm member configured to be movable between a lock position at which the arm member is engaged to the engagement portion and an unlock position at which the arm member is disengaged from the engagement portion, and
a biasing member configured to bias the arm member to the lock position, the arm member interfering with the storage medium moving in the first direction to move from the lock position to the unlock position and returning to the lock position at a position at which the connection terminal is connected to the terminal electrode to limit movement of the storage medium in the second direction, the lock mechanism being provided between the insertion port and the terminal electrode; and
a driving unit configured to move the arm member from the lock position to the unlock position according to an input operation with respect to the first button.

2. The electronic apparatus according to claim 1, wherein
the lock mechanism further includes a rotating shaft configured to abut against the storage medium moving in the first direction, to thereby rotate the arm member from the lock position to the unlock position.

3. The electronic apparatus according to claim 1, wherein
the driving unit includes
a cam configured to be engageable to the arm member,
a motor configured to rotate the cam, and
a control unit configured to control driving of the motor.

4. The electronic apparatus according to claim 3, wherein
the driving unit further includes a sensor configured to detect a rotation position of the cam, and
the control unit is configured to control the driving of the motor based on an output from the sensor.

5. The electronic apparatus according to claim 1, further comprising
a second button that is provided to the casing to mechanically move the arm member from the lock position to the unlock position by a pressing operation.

6. The electronic apparatus according to claim 1, wherein
the driving unit is configured to return the arm member to the lock position after the driving unit moves the arm member from the lock position to the unlock position and a predetermined period of time elapses.

7. The electronic apparatus according to claim 6, wherein
the driving unit is configured to move the arm member from the lock position to the unlock position again when the driving unit detects a power-off operation after the driving unit returns the arm member to the lock position.
